(19) United States
(12) Patent Application Publication
(10) Pub. No.: US 2007/0054116 A1
(43) Pub. Date: Mar. 8, 2007

(54) In-Mold Lamination Of A Decorative Product To A Primary Substrate

(76) Inventor: Mark K. NEITZKE, Waterford, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/428,093

(22) Filed: Jun. 30, 2006

Related U.S. Application Data
(63) Continuation of application No. PCT/US05/00253, filed on Jan. 3, 2005.
(60) Provisional application No. 60/533,636, filed on Dec. 31, 2003.

(51) Int. Cl. B32B 7/12; B32B 15/04

(52) U.S. Cl. 428/343

(57) ABSTRACT

A decorative trim panel which includes a shell of, preferably, flexible plastic having a front exposed surface and a back surface, a foam layer formed and adhered to the back surface of said shell, and an appliqué having a front surface and a back surface. The appliqué is formed to compliment the shape of a portion of the front exposed surface of the outer shell, and the appliqué further includes an adhesive layer between the back surface and the front surface of the skin, wherein the adhesive is activated during formation of the foam layer to adhere the appliqué′ to the shell. A corresponding method for production of the decorative trim panel is disclosed.

### CROSS REFERENCE TO RELATED APPLICATIONS

This application is a continuation of International Application No. PCT/US2005/000253 filed Jan. 3, 2005 and published Jul. 21, 2005 as International Publication No. WO 2005/065935, designating the United States, and which claims benefit of U.S. Provisional Application No. 60/533,636 filed Dec. 31, 2003.

### FIELD OF INVENTION

This invention relates to the in-mold application of decorative or protective thin-layer products to a primary substrate, particularly to thin-layer products that find use in automotive vehicles, and more particularly, to the lamination of thin-layer products during the urethane foaming process to form automotive trim panels.

### BACKGROUND OF THE INVENTION

Transportation vehicles, particularly automobiles, are marketed and sold on the basis of differentiation over other competitive models. Differentiation may be by style or color, and is often accomplished by using trim panels or appliqués on the interior or exterior of the vehicle which denote different levels of luxury, price or value. These appliqués or panels may also form protective coverings for areas that protrude from adjacent surfaces. These panels are generally color-coordinated with the adjacent surfaces of the vehicle but may also be bright, reflective, wood-grained, marbleized or metallized in appearance.

Originally, real wood appliqués and finished metal panels were used, however, their popularity suffered due to their high cost and limited durability. Subsequently, wood veneers and films with a vacuum-deposited metal layer found favor, however, these solutions did not produce the look of luxury or the extended durability required in today's marketplace.

Various proposals have been suggested and practiced for the manufacture of plastic composites for use as automotive interior trim and exterior trim panels or appliqués. One approach had been to form a metal or plastic substrate and apply multiple coatings thereon to produce a product with a high gloss Class A-surface. The substrates may be formed from steel, or any one of a wide range of known plastic materials such as ABS, PP, ABS/PC blends, PU, TPO, PET, PBT or other equivalent high strength plastic materials suitable for injection molding into a product shape. The coatings for such substrates may be selected from known coatings such as a primer coat, an adhesion promoter, a base coat and a clear coat, and in the case of metals, an electrodeposited coat. Examples of such coatings are set forth in U.S. Pat. Nos. 4,681,811 and 5,320,869. The solvents used in such systems may cause undesirable environmental and emission problems.

Another approach is to form a paint film and inject polymeric material behind the paint film to produce a part with a desired colormatch on its exposed Class A surface. Examples of known paint film and injection molded plastic parts are shown in U.S. Pat. Nos. 5,432,666 and 5,009,821. Such systems may require the separate manufacture and handling of the film. Furthermore, the outer surface being a paint film may not exhibit sufficient abrasion resistance.

Still another approach to providing a colored plastic part is to provide an enamel coating that will reduce emissions while producing a crater-resistant surface on the part being coated. One such system is set forth in U.S. Pat. No. 4,396,680. Such systems may require the use of conventional coating systems and baking ovens to form a finish on the substrate that has the desired appearance.

Yet another approach is to provide laminating equipment in which a color layer is formed by extrusion and then connected to a substrate. U.S. Pat. No. 4,349,592 discloses the use of such a technique in the manufacture of a decorative molding exterior trim part.

Various other proposals have been suggested to produce decorative trim parts and appliqué s which have unique patterns. For instance, U.S. Pat. No. 5,338,592 is directed at laminating a series of wood veneers to form an overlay sheet, finishing, cutting and drying the overlay to form a shape, molding a transparent resin layer onto the front surface of the wooden shape and molding a synthetic resin core material onto the rear surface of the wooden shape. However, the effort of forming the wooden veneer overlay to the desired shape is both time consuming and costly.

Similarly, U.S. Pat. No. 5,525,179 is directed at manufacturing a lining part comprising a blank having a preformed shape and a cutout with an edge, injection molding a first plastic material to form a back surface, followed by injection molding a second plastic material to form a front surface coating which also coats the edges of the part.

U.S. Pat. No. 6,444,317 is directed at preparing a laminate film including a polyolefin film layer and a primer layer and injection molding a polyolefin resin onto the polyolefin film layer to form an outer layer.

Regarding the preparation of other decorative wood articles, U.S. Pat. No. 6,444,319 assigned to Erwin Behr, GmbH & Co. is directed at the surface coating of an interior fitting for vehicles with a lacquer or resin layer wherein a wood veneer component is inserted into a mold and spaced from the cavity so that a liquid surface coating material having at least two mixed components may be introduced into the space between the mold and wood veneer component. United States Patent Application Publication Nos. 2003/0044598 and 2003/0162045, also to Behr, disclose the use of a liquid coating material curable by UV radiation, and the application of a coating material based on vegetable-oil-modified resin and natural vegetable oils, with the addition to the coating material of ceramic micro-particles, respectively.

Finally, United States Patent Application Publication No. 2002/0007898 is directed at a method of making a molded wood part having a wood grain pattern wherein a wood fiber substrate is formed, coated with a water impermeable material and a pattern transferred to the substrate using a hydrographic process. A protective top coat may be applied over the pattern. One example of a hydrographic process is disclosed in U.S. Pat. No. 4,010,057 wherein a thin film on which a pattern is printed is floated on the surface of a liquid and the pattern is transferred onto the surface of the object by submerging the surface of the object in the liquid.

The art is replete with references citing the injection of a molten polymer behind a film or foil to form a substrate which retains the film or foil in the desired configuration of the trim panel and which provides for attachment by way of integral bosses, fasteners and the like. U.S. Pat. No. 5,529,336, assigned to Larry J. Winget, and U.S. Pat. No. 6,395,219, assigned to Patent Holding Company, disclose appliqués made by processes where molten resins are employed.

U.S. Pat. No. 5,700,050, assigned to Cambridge Industries, Inc. is directed at a safety molding for an interior trim part wherein a cosmetic layer of material is integrally molded onto and bonded directly to the exterior of a parison as it is being blow molded to form a shell.

Additional means for decorating automotive trim panels with appliqués are disclosed in U.S. Pat. Nos. 5,439,630; 5,901,977; and 5,992,876 commonly assigned to the assignee of the present invention and included herein by reference. U.S. Pat. No. 5,439,630 is directed at a method of integrally molding a simulated leather appliqué with a plastic interior trim component for a motor vehicle wherein a thin shell is formed having a textured section with a deep groove therearound. A cushion foam block is press-fitted within the grooved section and foamed in place to form a simulated appliqué. U.S. Pat. No. 5,901,977 is directed at a separately molded appliqué installed on an air bag cover wherein the appliqué includes an outer head portion and laterally spaced flange portions which extend into the finishing cover to retain the cover from being pulled away when the air bag deploys. U.S. Pat. No. 5,992,876 is directed at a cover assembly for concealing an air bag restraint assembly wherein an appliqué is rigidly supported over an outer skin to prevent the skin from being torn loose during air bag deployment.

While the various methods are suitable for their intended purposes, they all involve processing considerations that either produce emissions or require unnecessary handling of one or more layers of material, and often the manufacture of a backing layer or substrate, in order to provide a decorative exterior or interior appliqué for a trim product.

Thus, there is a continuing need in this field of art for an article and its method of manufacture that will obviate the above problems. What is needed is an efficient process for attaching decorative thin-layered products to the outer surface of vehicle trim components.

### SUMMARY OF THE INVENTION

The present invention relates to an efficient production method for laminating a decorative or protective layer, or appliqué, to an automotive vehicle trim product. A thin-layer composite, preferably a foil, film, fabric or veneer is provided for decorating or protecting a portion of the surface of an interior trim product. These products may include but are not limited to, armrests, door panels, headrests, headliners, consoles, instrument panels, package shelves, air bag doors, garnish trim and the like.

In a first embodiment, a decorative trim panel is disclosed which includes a shell of flexible plastic having a front exposed surface and a back surface, a foam layer formed and adhered to the back surface of said shell, and an appliqué having a front surface and a back surface. The appliqué is formed to compliment the shape of a portion of the front exposed surface of the outer shell, and the appliqué further includes an adhesive layer on the back surface, wherein the adhesive is activated during formation of the foam layer to adhere the appliqué ′ to the shell.

In method form, the present invention comprises a method for forming a trim panel including an appliqué comprising the steps of:
(a) providing a molding apparatus including a cavity portion and a cover portion, said portions engagable to form said trim panel, said cavity portion including a cavity surface;
(b) providing a skin of a selected shape, said skin having an outer surface and a back surface;
(c) providing an appliqué having a shape which complements a portion of the outer surface of said skin, said appliqué having an outer surface and a back surface wherein said appliqué may include an adhesive coating and alternatively coating the back surface of said appliqué with an adhesive and allowing said adhesive to dry on the backside of said appliqué;
(d) placing said appliqué including said adhesive coated back surface in said cavity portion of said mold apparatus, said outer surface of said appliqué in contact with said cavity surface;
(e) placing said plastic skin in said cavity portion of said mold apparatus with said skin outer surface in contact with said cavity surface and said adhesive coated back surface of said appliqué;
(f) engaging said mold cavity and said mold cover to form an open space behind said skin back surface;
(g) providing urethane foam precursors into said open space and against at least a portion of said back surface of said skin;
(h) allowing said urethane foam precursors to react and generate heat and pressure as they fill said open space with foam;
(i) allowing said generated heat to activate said adhesive layer to adhere said appliqué to said skin outer surface; and
(j) removing said trim panel from said mold apparatus.

The thin-layer composite may be a single layer or a multi-layer construction to provide the protective or decorative properties desired. The thin layer composite may be formed to shape to match the outer contour of the trim product by vacuum forming, pressure forming or a similar process. The formed shape or appliqué may be coated on the backside with an adhesive, preferably a thermosetting plastic which is heat-activatable and, more preferably, a moisture curable urethane composition. In alternative embodiments, the coating may be applied to the surface of the skin, and/or a flat appliqué may be provided which is formed to shape by the foaming pressure. A mold assembly comprising a mold lower half, including a cavity portion having the outer shape of the trim product, and a mold upper half or cover portion, having the shape of the backside of the trim product is provided. Within the cavity portion of the lower half of the mold set is an area, preferably including a ridge in the cavity surface, which defines the periphery where the appliqué will be placed. This area, preferably defined by a peripheral ridge, further includes preferably, a series of holes connected to a source of vacuum for retaining the appliqué to the mold surface. The adhesive-coated appliqué is placed with its outer decorative surface in contact with the mold cavity in the defined area and vacuum is applied to retain the appliqué in place. A skin which will form the outer surface of the interior trim product is next loaded into the mold cavity and against the adhesive-coated backside of the appliqué to provide surface to surface contact. The skin is next backfilled using a reactive polymer composition, preferably, a urethane foam, and the mold closed. The exothermic heat of reaction and resulting pressure of foam expansion provide intimate contact of the skin outer surface to the adhesive-coated side of the appliqué and activate the adhesive.

Upon demolding, a finished appliqué-decorated trim product is provided, without the need for additional substrate layers or auxiliary fastening means. The lamination of the appliqué to the outer surface of the trim panel occurs as part of one of the primary processing steps in forming the trim product.

Accordingly, it is an object of the present invention to provide an efficient manufacturing process for decorating the outer surface of an automotive trim panel.

It is a further object of the present invention to provide trim products having decorative or protective appliqué applied using the above process.

It is a still further object of the present invention to adhere films, foils, fabrics, sheets of metal or composite, flex circuits and veneers as appliqué s to the primary surface of automotive trim products as part of the primary processing steps to form those products, using a heat-activatable adhesive.

It is a further object of the present invention to provide an efficient means to retain appliqué s to interior trim products through the use of the exothermic heat and the expansion pressure of a urethane foam to activate an adhesive layer located between the back surface of the appliqué and the primary surface of the trim product.

It is a still further object of the present invention to provide automotive interior trim products decorated with an appliqué in which the appliqué appears to be integral with the trim product and not protruding from the surface.

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

### BRIEF DESCRIPTION OF THE DRAWINGS

The features, operations and advantages of the present invention may be better understood from the following detailed description of the preferred embodiments taken in conjunction with the attached drawings in which,

FIG. 1 is a perspective view of a vehicle instrument panel including an appliqué provided by the present invention,

FIG. 2 is a perspective view of a vehicle door panel including an appliqué provided by the present invention,

FIG. 3 is a block diagram reciting the steps of the preferred lamination process, and

FIG. 4 is a representative cross-sectional view of the apparatus used in making the invention.

### DETAILED DESCRIPTION OF THE INVENTION

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly referenced at 10A, 10B and so forth in subsequent embodiments. Thus, where an embodiment description uses a reference character to refer to an element, the reference character applies equally, as distinguished by alphanumeric character, to the other embodiments where the element is common.

Automotive interior trim products generally have a soft pliable outer surface comprising, preferably, a leather, fabric or plastic skin which is backed by a low density, generally foam, cushioning layer and, optionally, by a rigid substrate layer which provides attachment for adjacent componentry as well as for the trim panel.

Trim products such as instrument panels are manufactured preferably by three primary processes; substrate molding, skin molding and foam molding. The rigid substrate is generally injection molded of a thermoplastic resin. Metal, woodstock and other rigid materials may also be used. The pliable skin material is generally a thermoplastic composition such as polyurethane, poly(vinyl)chloride (PVC), thermoplastic olefin, thermoplastic elastomer, acrylic-styrene-acrylonitrite and the like, cast to shape as a liquid or powder and solidified. Alternatively, calendared sheet materials such as PVC/ABS blends, thermoplastic olefins and thermoplastic elastomers may be heated and formed under vacuum and pressure to provide the outer shaped skin of the trim product. Also textile materials such as cloth and fabric or even leather may be used as the outer skin for a trim panel. The molded substrate and cast or formed skin are then joined together in the foaming process.

The molded substrate and pliable skin are generally foamed-in-place using a two portion mold assembly, one half of which contains the pliable outer skin and the opposed half containing the optional substrate layer. The two mold halves cooperate when engaged to create an open space between the skin and substrate into which liquid urethane foam precursors may be provided. Upon engaging the mold halves, the liquid precursors exothermally react and expand to fill out the open space. The urethane foam cushioning layer thus created is generally between about 5 and about 20 lbs./cubic foot in density. The foam precursors may be delivered to a closed mold through an injection port and runner system known in the art as “closed mold injection pour”. Alternatively, the foam precursors may be provided into an open mold, wherein the two mold halves are separated and the foam precursor is poured through a mixing head articulated by a robot or by a person to distribute the foam over most of the backside of the pliable skin. The mold halves are then quickly engaged to seal the expanding precursors between the skin and substrate. In the case of lightweight non-structural and flat trim products, such as door panels and headliners, the substrate layer may not be needed. In this instance, a more rigid urethane foam is provided often with a layer of glass mat, or the like, which is impregnated during the foam expansion to provide some rigidity for handling the molded product.

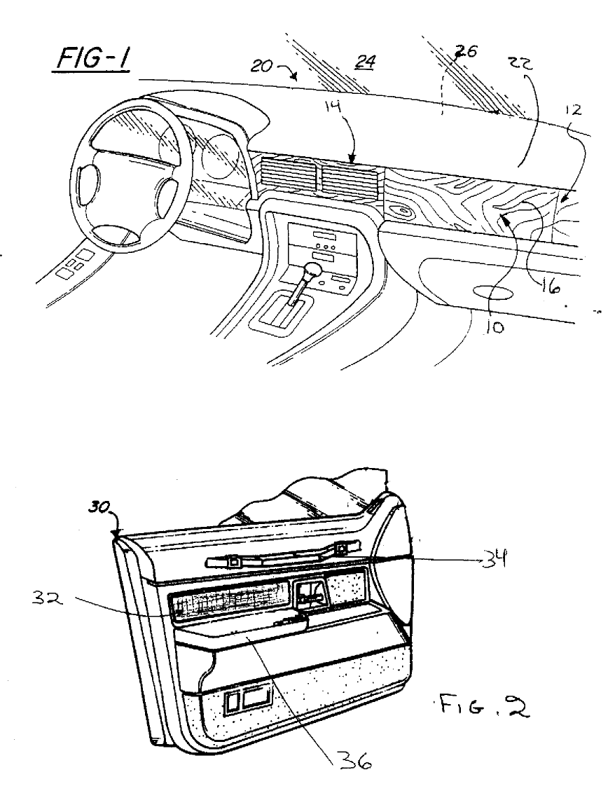

FIG. 1 is a perspective view of an automobile cockpit with the main instrument panel shown beneath a windshield 24. Beneath the instrument panel, typically, there is a hidden air bag deployment system 26 whose presence is not evident on the top surface. Decorating the surface of the instrument panel 20, is an outer skin 22 and three coordinated appliqués 10, 12 and 14 which include a wood grain pattern 16 that flows smoothly from panel to panel. Often this wood appearance flows completely across the instrument panel and along the door panels, down each side of the vehicle. By providing an appliqué with the appearance of lightly buffed expensive wood, the interior appearance of the vehicle is enhanced and differentiated.

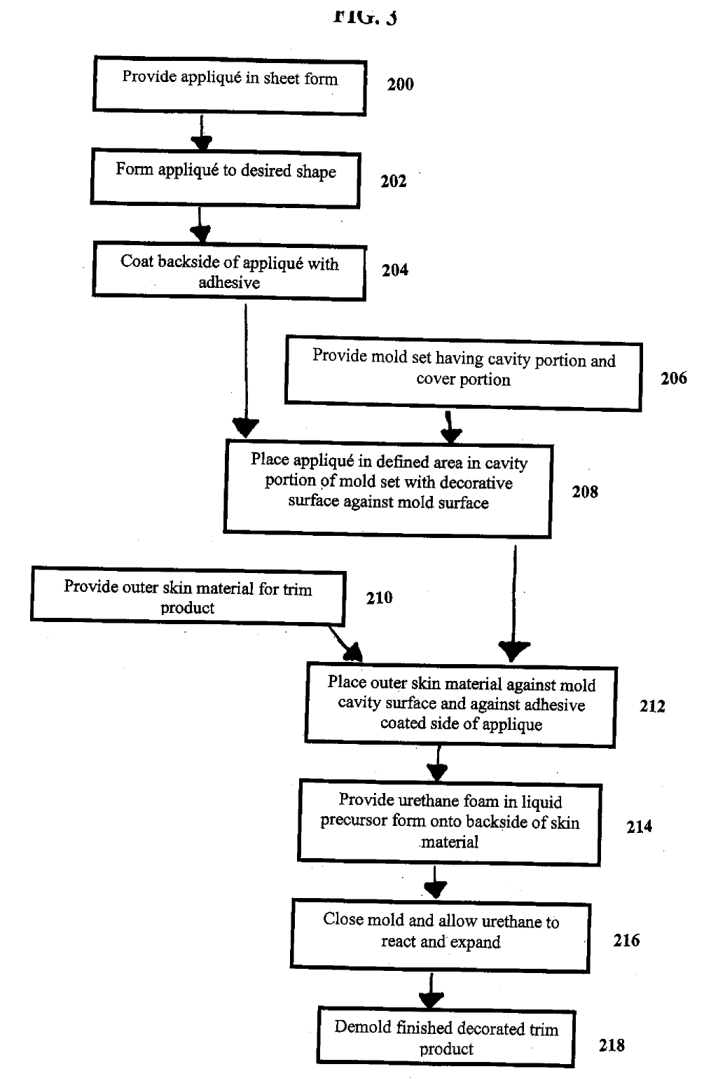

A second decorative appliqué is shown in FIG. 2 where a door panel 30 which includes a grab handle 34 and armrest 36 further includes a decorative appliqué 32, in this case having the appearance of a burnished metal.

The apparatus and method for laminating these decorative appliqués as part of the third primary forming process, the foaming process, will now be described.

FIG. 4 is a representative cross-sectional view of a molding apparatus 40 used in making the invention. The molding apparatus 40 is a urethane foam mold comprising two mating halves, a cavity portion 42 and a cover portion 44. The cover portion 44 retains a rigid plastic, preferably injection molded, substrate 46 in spaced relationship from the cavity portion 42. The cavity portion 42 retains a pliable outer skin 22A in spaced relationship to the rigid substrate 46. Lying beneath the pliable skin 22A is a, preferably, formed to shape appliqué 10A having a decorative front surface 50 and a heat-activatable adhesive coated backside 52, in contact with the pliable skin layer 22A. In this embodiment, the molding apparatus includes an injection port 48 through the mold cover 44 which allows foam precursors to be injected into the space between the spaced apart substrate 46 and skin 22A which then react to form the foam cushioning layer 54. Also shown in FIG. 4 are protrusions 60 which may be used to align the appliqué 10A in the mold cavity portion 42 and vacuum channels 62 for providing a vacuum to retain the appliqué in position during foam processing.

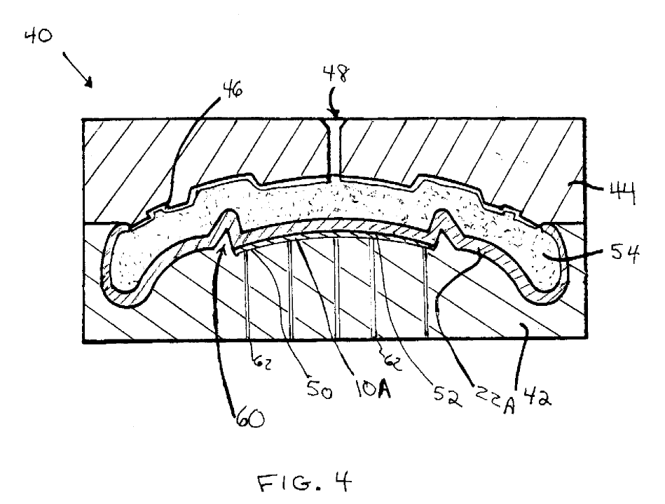

The preferred method for laminating the appliqué is described in block diagram form in FIG. 3. A decorative or protective sheet of material is provided for use on the surface of a trim product, preferably for a vehicle. (Block 200) This sheet of material may comprise any of a film, foil, fabric, veneer, metal or composite, flex circuit and the like. This material may be a single layer or comprised of multiple layers to yield the deserved decorative or protective results. This material may include, but is not limited to, a wood grain laminate, a metallized foil, a paint film and a fabric capable of being formed. One example of a formable laminate of this type is Avery Dennison™ Thermark® Decorative Formable Finishes. Another formable film is Avery Dennison™ Soft Laminate® Formable Decorative Film. A further example is Avery Dennison™ Avloy® Dry Paint R film. The sheet of material is next formed to shape (Block 202) to fit the surface of the mold cavity portion (42 in FIG. 4) and compliment the outer shape of a pliable skin material which has been cast or formed to shape as the outer surface of a trim product. The formed appliqué is next coated with a heat-activatable adhesive, preferably a moisture cure urethane composition, such as EFTEC HL9588VF, and the adhesive allowed to dry. (Block 204) Other types of curing adhesives may also be used, including but not limited to, epoxy, polyester, urea-formaldehyde, melamine-formaldehyde, silicone and cyano-acrylic. In addition, polymers which have a B-stage or partially cured form may be used.

A molding apparatus, preferably comprising two engagable mold halves, a cavity portion and a cover portion are provided (Block 206). The cavity portion of the mold set includes a defined area, preferably outlined by a surface feature such as a ridge or depression which allows the formed appliqué to be properly located (Block 208, see 60 in FIG. 2). The appliqué is placed with its decorative or outer surface against the mold surface and the adhesive coated back surface facing out. A source of vacuum is connected to channels which terminate as holes in the defined area to hold the appliqué in place.

The outer skin of the trim product being manufactured (Block 210) is next located in the mold cavity portion and against the adhesive-coated backside of the appliqué (Block 212). This provides surface to surface contact of the adhesive-coated appliqué to the outer skin. A rigid plastic substrate may next be loaded onto the cover portion of the mold set and the mold halves engaged or closed to locate the skin and substrate in spaced relationship. At Block 214, a urethane foam composition in the form of liquid precursors is applied to the back surface of the outer skin. This may be accomplished by pouring, injecting or spraying the liquid preferably over most of the back surface of the skin. The urethane foam precursors next react in the closed mold (Block 216) and expand to fill out any open space within the mold set and to adhere the skin and substrate together, forming the trim product. This exothermic reaction generates sufficient heat to activate the moisture cured adhesive causing that layer to cure and adhesively bond the appliqué to the outer surface of the skin. In addition, the exothermic reaction of the liquid precursors initiates expansion of the urethane precursor liquid into a foam, compressing the skin tightly against the adhesive coated backside of the appliqué. The temperature generated by the reaction is preferably between about 95 to about 115 degrees F. at the adhesive surface, although higher temperatures may be used. The pressure generated by the expanding foam mass is preferably between about 10 psi to about 40 psi but most preferably between about 30 to about 35 psi. After the urethane foam has cured sufficiently for handling, preferably about 3 to about 6 minutes, the trim panel may be removed from the mold and trimmed (Block 218). While the preferred embodiment has been described herein, other methods to provide a similarly decorated trim product may be possible. For example, the moisture cured urethane adhesive may be applied to a defined area of the outer skin rather than to the backside of the appliqué. A separate source of heat may be installed in the mold cavity adjacent the defined area, which can be used as needed to locally heat the appliqué and initiate curing of the adhesive layer. The skin may be heated prior to being supplied to the mold cavity to aid in activating the adhesive. It is further well known in the art to provide adhesive materials which may be activated at higher temperatures to accommodate the instance of high ambient temperature in a molding environment. Alternate foam materials such as polystyrene, polyolefin and epoxy may be provided behind the skin layer and expanded with heat to provide the temperature and pressure required to allow the adhesive to cure. In a still further alternate embodiment, the same molding apparatus may be configured to be used to manufacture trim panels with or without an appliqué′ molded in place, by allowing the skin material to expand out to fill the space normally occupied by the appliqué′, saving on the number of molds needed to provide trim panels for multiple vehicle models.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A decorative trim panel comprising:
a skin having a front exposed surface and a back surface;
a foam layer formed and adhered to the back surface of said shell;
an appliqué having a front surface and a back surface, said appliqué further including an adhesive layer on the back surface, wherein said adhesive is activated during formation of said foam layer to adhere said appliqué′ to said skin.

2. The trim panel of claim 1, wherein said appliqué is formed to compliment the shape of a portion of said front exposed surface of said outer shell

3. The trim panel of claim 1, further including a substrate layer attached to said foam layer.

4. The trim panel of claim 1, wherein said appliqué comprises one of a foil, laminate, fabric, veneer, flex circuit, film, metal and composite.

5. The trim panel of claim 1, wherein said adhesive comprises any one of a polyurethane, an epoxy, a silicone, an acrylic composition, and a formaldehyde composition.

6. The trim panel of claim 5, wherein said adhesive is a moisture cure urethane composition.

7. The trim panel of claim 1, wherein the skin comprises any one of, or combination of, leather, fabric, and plastic.

8. The trim panel of claim 1, wherein said adhesive is activated by the heat of exotherm of said foam.

9. The trim panel of claim 1, wherein said adhesive is activated by heat provided other than by the heat of exotherm of said foam.

10. A method for forming a trim panel including an appliqué comprising the steps of:
(a) providing a molding apparatus including a cavity portion and a cover portion, said portions engagable to form said trim panel, said cavity portion including a cavity surface;
(b) providing a skin having an outer surface and a back surface;
(c) providing an appliqué having an outer surface and a back surface, said back surface coated with an adhesive;
(d) placing said appliqué including said adhesive coated back surface in said cavity portion of said mold apparatus, said outer surface of said appliqué in contact with said cavity surface;
(e) placing said skin in said cavity portion of said mold apparatus with said skin outer surface in contact with said cavity surface and said adhesive coated back surface of said appliqué;
(f) engaging said mold cavity and said mold cover to form a open space behind said skin back surface;
(g) providing foam precursors into said open space and against at least a portion of said back surface of said skin;
(h) allowing said foam precursors to react and generate heat and pressure as they fill said open space with foam;
(i) allowing said generated heat to activate said adhesive layer to adhere said appliqué to said skin outer surface; and
(j) removing said trim panel from said mold apparatus.

11. The method of claim 10, further including the step of placing a rigid substrate on the cover portion of the mold apparatus prior to step (f).

12. The method of claim 10, further including the step of placing a glass mat in the open space formed in step (f).

13. The method of claim 10, wherein said appliqué comprises one of a foil, laminate, fabric, veneer. flex circuit, film, metal and composite.

14. The method of claim 10, wherein said adhesive comprises any one of a polyurethane, an epoxy, a silicone, an acrylic composition, and a formaldehyde composition.

15. The method of claim 14, wherein said adhesive is a moisture cure urethane composition.
